(19) United States
(12) Patent Application Publication
(10) Pub. No.: US 2008/0170896 A1
(43) Pub. Date: Jul. 17, 2008

(54) RELEASE-PROMOTING AGENT, FIXING DEVICE, AND IMAGE FORMING APPARATUS

(76) Inventors: Keisuke Kubota, Ibaraki (JP); Teruaki Mitsuya, Ibaraki (JP); Takashi Suzuki, Ibaraki (JP); Yoshihiro Sonohara, Ibaraki (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/554,343

(22) Filed: Oct. 30, 2006

(30) Foreign Application Priority Data
Oct. 31, 2005 (JP) 2005-316041

(51) Int. Cl. G03G 15/20

(52) U.S. Cl. 399/340

(57) ABSTRACT

A release-promoting agent is configured to be applied to a heating member in a fixing device that presses the heating member against a recording medium on which a toner image is formed and fixes the toner image to the recording medium, to promote release of the toner image from the heating member. The release-promoting agent is formed with a mixture of a dimethyl polysiloxane and an amino group-containing dimethyl polysiloxane represented by

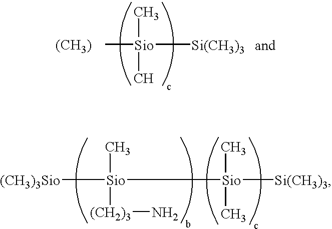

respectively, where b≠0, and c>1000.

### CROSS-REFERENCE TO RELATED APPLICATIONS

The present document incorporates by reference the entire contents of Japanese priority document, 2005-316041 filed in Japan on Oct. 31, 2005.

### BACKGROUND OF THE INVENTION

1. Field of the Invention

The present invention relates to a technology for fixing a toner image on a recording medium.

2. Description of the Related Art

Generally, conventional image forming apparatuses, such as a copying machine, a facsimile, and a printer, which form a toner image use a fixing device to fix a toner image on a recording medium such as a recording sheet. One of known fixing devices is described in Japanese Patent Application Laid-open No. 2002-162859. The known fixing device stretches a fixing belt having a surface layer made of a fluororesin formed on its top side by a fixing roller and a heating roller, and presses the heating roller in contact with the top side of the belt toward the fixing belt, thereby forming a fixing nip. The fixing belt is heated by the heating roller while being moved in an endless motion with the rotation of the fixing roller. A recording medium like a recording sheet fed into the fixing nip is pressed by the fixing belt, thereby fixing the toner image on the surface of the recording medium. The recording medium that has passed the fixing nip is separated from the fixing belt and the pressure roller surface layer to undergo a next process. Transfer of the toner image on the surface to the fixing belt, which is called “offset”, can occur at the time of the separation. As a solution to the problem, silicone oil as a release-promoting agent is applied to the top side of the belt member by an application roller to improve the releasability of a toner from the fixing belt, thereby suppressing the offset of the toner image.

In the fixing device having the above configuration, as silicone oil applied to the belt member, there has generally been used inexpensive dimethyl silicone oil represented by

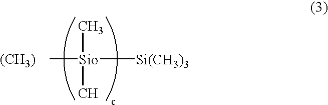

wherein c=100 to 300.

However, the dimethyl silicone oil has a poor affinity with the surface layer of the fixing belt made of a fluororesin, and hence does not smoothly wet the surface layer, causing local offset. Therefore, the occurrence of the offset cannot be surely prevented.

As another silicone oil applied to the belt member, there has been known amino-modified silicone oil comprised mainly of an amino group-containing organopolysiloxane represented by Formula (4) and an amino group-containing organopolysiloxane represented by Formula (5).

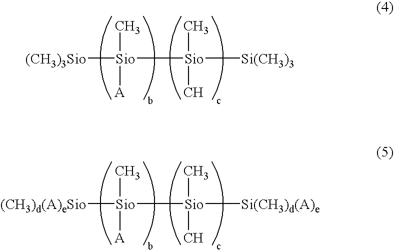

wherein 0≦b≦10, 10≦c≦1,000, b and e does not become zero at the same time, d+e=3, and A=(CH₂)₃—NH₂.

The amino-modified silicone oil smoothly wets the surface layer of the fixing belt made of a fluororesin, and spreads thereon, thereby surely preventing the occurrence of offset.

However, the amino-modified silicone oil has a disadvantage in that it is more expensive, as compared with the dimethyl silicone oil, and hence increases the cost.

### SUMMARY OF THE INVENTION

It is an object of the present invention to at least partially solve the problems in the conventional technology

A release-promoting agent according to one aspect of the present invention is configured to be applied to a heating member in a fixing device that presses the heating member against a recording medium on which a toner image is formed, and fixes the toner image to the recording medium, to promote release of the toner image from the heating member. The release-promoting agent is formed with a mixture of a dimethyl polysiloxane represented by

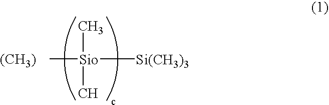

and an amino group-containing dimethyl polysiloxane represented by

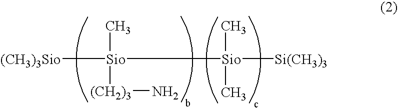

where b≠0, and c>1000.

A fixing device according to another aspect of the present invention includes an endless belt member that is tightly stretched by a plurality of tension members, and moves in an endless motion; a bottom-side roller that abuts on a back surface of the belt member; a pressure roller that is pressed toward the bottom-side roller in abutment with a surface of the belt member; a heating unit that heats the belt member; and an applying unit that applies a release-promoting agent to the surface of the belt member. A recording medium on which a toner image is formed is nipped by a fixing nip formed by abutment of the belt member and the pressure roller, and is heated, thereby fixing the toner image on the recording medium. The release-promoting agent is formed with a mixture of a dimethyl polysiloxane represented by Formula (1) and an amino group-containing dimethyl polysiloxane represented by Formula (2).

An image forming apparatus according to still another aspect of the present invention includes a forming unit that forms a toner image on a recording medium; and a fixing device that fixes the toner image on the recording medium. The fixing device includes an endless belt member that is tightly stretched by a plurality of tension members, and moves in an endless motion; a bottom-side roller that abuts on a back surface of the belt member; a pressure roller that is pressed toward the bottom-side roller in abutment with a surface of the belt member; a heating unit that heats the belt member; and an applying unit that applies a release-promoting agent to the surface of the belt member. The recording medium on which the toner image is formed is nipped by a fixing nip formed by abutment of the belt member and the pressure roller, and is heated, thereby fixing the toner image on the recording medium. The release-promoting agent is formed with a mixture of a dimethyl polysiloxane represented by Formula (1) and an amino group-containing dimethyl polysiloxane represented by Formula (2).

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a copier that applies an image forming method according to an embodiment of the present invention;

FIG. 2 is a partially enlarged configuration diagram of a part of an internal configuration of a printer unit according to the present embodiment;

FIG. 3 is a partially enlarged view of a part of a tandem portion in the printer unit;

FIG. 4 is an enlarged configuration diagram of a fixing device of the printer unit;

FIG. 5 is an enlarged cross-section of a fixing belt of the fixing device;

FIG. 6 is an enlarged configuration diagram of an application device of the fixing device, together with parts of a heating roller and the fixing belt;

FIG. 7 is a schematic diagram of a test image;

FIG. 8 is a graph of a relationship between a surface temperature of the fixing belt and a gloss level of the test image;

FIG. 9 is an enlarged cross-section of a fixing roller and a pressure roller in a fixing device that employs a fixing nip of a protrusive fixing type;

FIG. 10 is an enlarged cross-section of a fixing roller and a pressure roller in a fixing device of the copier;

FIG. 11 is a schematic diagram of a test image employed in an experiment of two-sided printout;

FIG. 12 is a graph of relationships among a discharge amount (X coordinate) of a transfer sheet from the fixing nip, a position (Y coordinate) in a direction perpendicular to the transfer sheet, and a type of oil, when a pressure roller having a surface layer made of PFA (tetrafluoroethylene perfluoroalkyl vinyl ether polymer) coated thereon is used;

FIG. 13 is a graph of relationships among a discharge amount (X coordinate) of a transfer sheet from the fixing nip, a position (Y coordinate) in a direction perpendicular to the transfer sheet, and a type of the oil, in the fixing device of the copier; and

FIG. 14 is an enlarged configuration diagram of one example of a fixing device of a roller fixing method.

### DETAILED DESCRIPTION OF THE PREFERRED EMBODIMENTS

Exemplary embodiments of the present invention will be explained below in detail with reference to the accompanying drawings. According to the present embodiment, the present invention is applied to an image forming method that forms an image using an electrophotographic copying machine (hereinafter, simply “copier”).

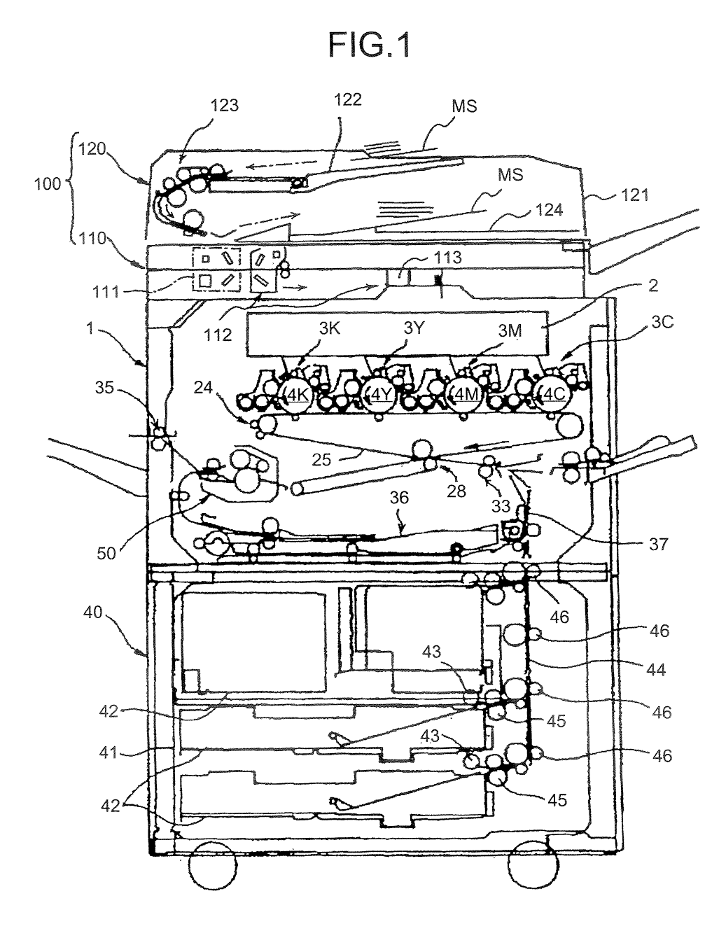

The basic configuration of a copier to be used in the image forming method according to an embodiment is explained first. FIG. 1 is a schematic configuration diagram of the copier. The copier includes a printer unit 1, a blank-paper feeding device 40, and a document feeding/scanning unit 100. The document feeding/scanning unit 100 includes a scanner 110 serving as a document scanning device fixed on the printer unit 1, and an auto document feeder (ADF) 120 serving as a document feeding device supported on the scanner 110.

The blank-paper feeding device 40 includes two paper feeding cassettes 42 arranged in multiple tiers in a paper bank 41, a feed roller 43 that feeds transfer sheets from the paper feeding cassette 42, and a separation roller pair 45 that separates a transfer sheet fed by the feed roller 43 and feeds the transfer sheets to a paper feeding path 44. The blank-paper feeding device 40 also includes a plurality of feed roller pairs 47 that feed a transfer sheet to a paper feeding path 37 in the printer unit 1. A transfer sheet on each paper feeding cassette is fed into the paper feeding path 37 in the printer unit 1.

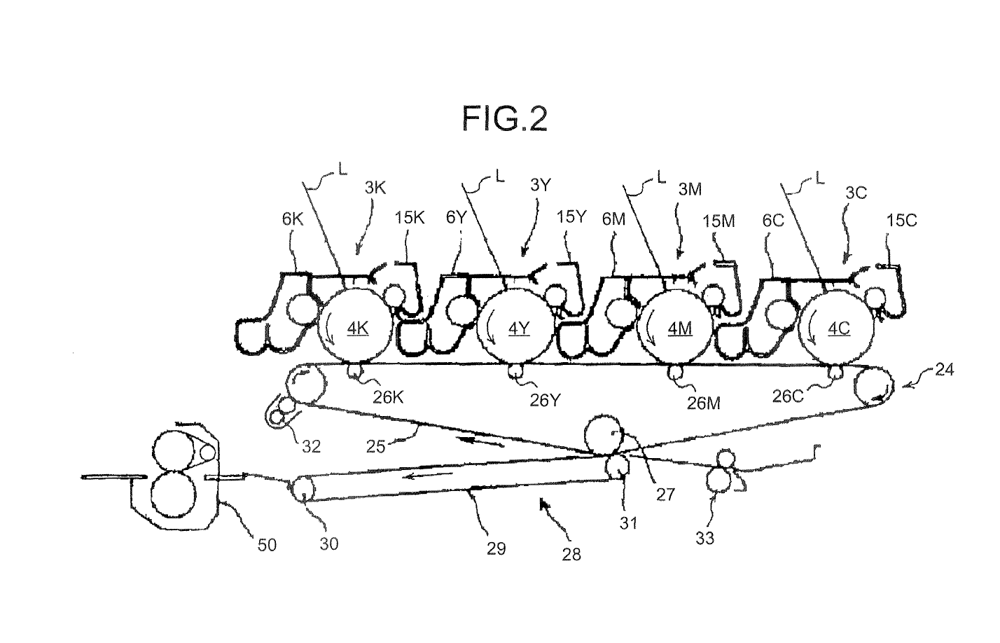

FIG. 2 is a partially enlarged configuration diagram of a part of the internal configuration of the printer unit 1. The printer unit 1 includes an optical writing device 2, four processing units 3K, 3Y, 3M, 3C that respectively form toner images of K (black), Y (yellow), M (magenta), and C (cyan) colors, a transfer unit 24, a paper feeding unit 28, a resist roller pair 33, a fixing device 50, a switchback device 36, and the paper feeding path 37. A light source, such as a laser diode or a light emitting diode (LED) (both not shown), provided in the optical writing device 2 is driven to emit a laser beam L toward four drum-shaped photosensitive elements 4K, 4Y, 4M, 4C. The beam emission forms an electrostatic latent image on the surface of each of the photosensitive elements 4K, 4Y, 4M, 4C. The latent image is developed into a toner image through a predetermined developing process. The letters K, Y, M, and C attached to reference numerals indicate that the associated components have black, yellow, magenta, and cyan specifications.

Each of the processing units 3K, 3Y, 3M, 3C supports the associated photosensitive element and various devices arranged therearound as a single unit on a common support, and is detachable from the main unit of the printer unit 1. The black processing unit 3K taken as an example has the photosensitive element 4K, and a developing device 6K that develops an electrostatic latent image, formed on the surface of the photosensitive element 4K, into a black toner image. The processing unit 3K also includes a drum cleaning device 15 that cleans a transfer residual toner remaining on the surface of the photosensitive element 4K after passing a primary transfer nip (later described) for K. As shown in FIG. 2, the copier has a so-called tandem configuration having the four processing units 3K, 3Y, 3M, 3C arranged facing an intermediate transfer belt 25 (described later) in the direction of the endless motion thereof.

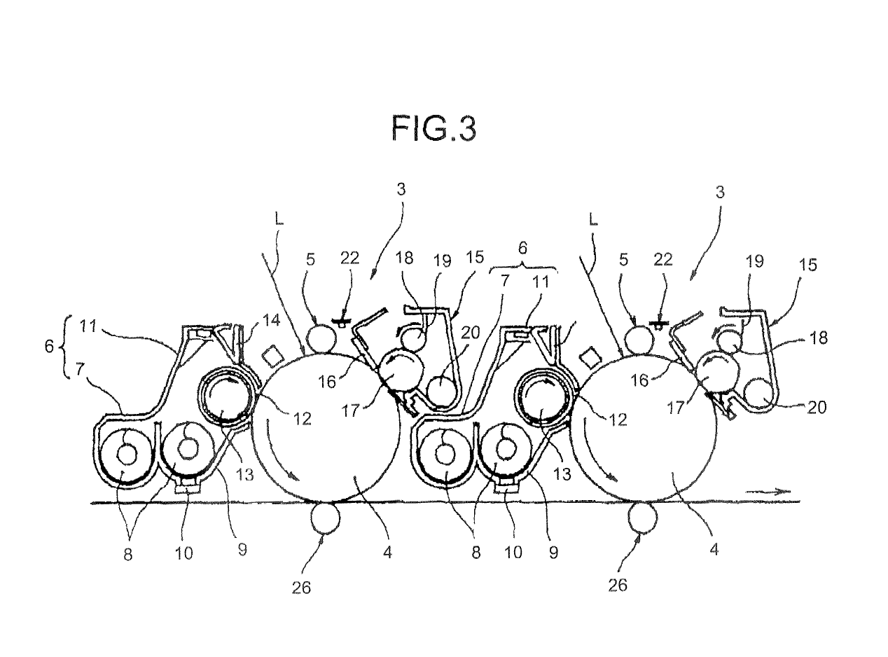

FIG. 3 is a partially enlarged view of a part of the tandem portion including the four processing units 3K, 3Y, 3M, 3C. Because the four processing units 3K, 3Y, 3M, 3C have nearly the same configuration except that toners of different colors are used, the letters K, Y, M, and C attached to the reference numerals in FIG. 3 are omitted. As shown in FIG. 3, the processing unit 3 includes a charging device 23, the developing device 6, the drum cleaning device 15, and a static-eliminating lamp 22 arranged around the photosensitive element 4.

A drum-shaped member on which a photoconductive layer having a photoconductive organic photoconductive material applied to a base tube of aluminum or the like is formed is used as the photosensitive element 4. Note that an endless belt member can be used instead.

The developing device 6 uses a 2-component developer containing a magnetic carrier and a non-magnetic toner (both not shown) to develop a latent image. The developing device 6 includes an agitating unit 7, and a developing unit 11. The agitating unit 7 supplies the 2-component developer retained therein while agitating it to a developing sleeve 12. The developing unit 11 transfers the toner in the 2-component developer carried by the developing sleeve 12 onto the photosensitive element 4.

The agitating unit 7 is provided below the developing unit 11, and includes two feed screws 8 provided in parallel to each other, a partition provided between the screws, and a toner density sensor 10 provided on the bottom side of a developer case 9.

The developing unit 11 includes the developing sleeve 12 facing the photosensitive element 4 through an opening of the developer case 9, a magnet roller 13 provided unrotatably in the developing sleeve 12, and a doctor blade 14 whose leading end comes close to the developing sleeve 12. The developing sleeve 12 is a non-magnetic rotatable cylinder. The magnet roller 13 includes a plurality of magnetic poles arranged sequentially in the rotational direction of the developing sleeve 12 from the opposing position to the doctor blade 14. The magnetic poles apply a magnetic force to the 2-component developer on the developing sleeve 12 at a predetermined position in the rotational direction. Accordingly, the surface of the developing sleeve 12 attracts and carries the 2-component developer fed from the agitating unit 7, thereby forming a magnetic brush on the sleeve surface along the magnetic flux.

The magnetic brush has its layer thickness restricted to an adequate thickness when passing the opposing position to the doctor blade 14 with the rotation of the developing sleeve 12 or the developer carrier, and is then fed to the developing region facing the photosensitive element 4. The toner is transferred on the electrostatic latent image to be developed by the potential difference between the developing bias to be applied to the developing sleeve 12 and the potential of the electrostatic latent image on the photosensitive element 4. As the developing sleeve 12 rotates, the toner returns to the developing unit 11, is separated from the sleeve surface due to the action of a repellent magnetic field formed between the magnetic poles of the magnet roller 13, and then returns to the agitating unit 7. An adequate amount of toner is supplemented to the 2-component developer in the agitating unit 7 based on the result of detection by the toner density sensor 10. The developing device 6 that uses the 2-component developer can be replaced with a type that uses a 1-component developer containing no magnetic carrier.

Although the drum cleaning device 15 is of a type that presses a cleaning blade 16 of polyurethane rubber against the photosensitive element 4, other types of cleaning devices can be used. To enhance the cleaning power, the drum cleaning device 15 includes a contact conductive fur brush 17 whose outer surface comes in contact with the photosensitive element 4 and which is arranged rotatable in the direction of the arrow in FIG. 3. The fur brush 17 also serves to scrape a lubricant from a solid lubricant (not shown) to form minute powder and apply the powder to the surface of the photosensitive element 4. A metallic electric field roller 18 that applies a bias to the fur brush 17 is provided rotatable in the direction of the arrow in FIG. 3, and the leading end of a scraper 19 is pressed against the electric field roller 18. The toner adhered to the fur brush 17 is transferred to the electric field roller 18 that is applied with a bias while rotating in contact with the fur brush 17 in the counter direction. After the toner is scraped off from the electric field roller 18 by the scraper 19, the toner falls on a collection screw 20. The collection screw 20 feeds the collected toner toward the end portion of the drum cleaning device 15 in a direction perpendicular to the surface shown in FIG. 3 to supply the toner to an external recycle feeding device 21. The recycle feeding device 21 sends the collected toner to the drum cleaning device 15 for recycling.

The static-eliminating lamp 22 eliminates electrostatic from the photosensitive element 4 by light illumination. The surface of the static-eliminated photosensitive element 4 is uniformly charged by the charging device 23, and is then subject to an optical writing process by the optical writing device 2. The charging device 23 in use is configured such that a charge roller to be applied with a charge bias is rotated in abutment with the photosensitive element 4. A scorotron charger or the like that performs a charge process on the photosensitive element 4 in a non-contact manner can be used.

With reference to FIG. 2, K, Y, M, and C toner images are formed on the photosensitive elements 4K, 4Y, 4M, 4C of the four processing units 3K, 3Y, 3M, 3C through the processes described above.

The transfer unit 24 is disposed under the four processing units 3K, 3Y, 3M, 3C. The transfer unit 24 moves the intermediate transfer belt 25, stretched by a plurality of rollers, in an endless motion in a clockwise direction in FIG. 2 in abutment with the photosensitive elements 4K, 4Y, 4M, 4C. This forms primary transfer nips for K, Y, M, and C where the photosensitive elements 4K, 4Y, 4M, 4C contact the intermediate transfer belt 25. Near the primary transfer nips for K, Y, M, and C, the intermediate transfer belt 25 is pressed toward the photosensitive elements 4K, 4Y, 4M, 4C by primary transfer rollers 26K, 26Y, 26M, 26C arranged inward of the belt loop. Primary transfer biases are applied to the primary transfer rollers 26K, 16Y, 26M, 26C by respective power supplies (not shown). Accordingly, primary transfer magnetic fields that electrostatically move the toner images on the photosensitive elements 4K, 4Y, 4M, 4C toward the intermediate transfer belt 25 are formed in the primary transfer nips for K, Y, M, and C. With the endless belt movement in the clockwise direction in FIG. 2, the toner images are transferred onto the top side of the intermediate transfer belt 25, which passes the primary transfer nips for K, Y, M, and C sequentially, one on another at the respective primary transfer nips (primary transfer). This latent-images overlaying primary transfer forms four-color overlaid toner images (hereinafter, “four-color toner images”) on the top side of the intermediate transfer belt 25.

Under the transfer unit 24 in FIG. 2, the paper feeding unit 28 that puts an endless paper feeding belt 29 stretched between a drive roller 30 and a secondary transfer roller 31 is provided. The intermediate transfer belt 25 and the paper feeding belt 29 are held between the secondary transfer roller 31 and a lower tension roller 27 of the transfer unit 24. This forms a secondary transfer nip where the top side of the intermediate transfer belt 25 abuts on the top side of the paper feeding belt 29. A secondary transfer bias is applied to the secondary transfer roller 31 by a power supply (not shown). The lower tension roller 27 of the transfer unit 24 is grounded. Accordingly, a secondary transfer electric field is formed in the secondary transfer nip.

The resist roller pair 33 is arranged to the right to the secondary transfer nip in FIG. 2, and a transfer sheet held between the rollers 33 is sent to the secondary transfer nip at a timing synchronous with the four-color toner images on the intermediate transfer belt 25. In the secondary transfer nip, the four-color toner images on the intermediate transfer belt 25 are collectively transferred to the transfer sheet by the secondary transfer electric field and the nip pressure (secondary transfer), and become, together with the white color of the transfer sheet, a full-color image. The transfer sheet that has passed the secondary transfer nip is separated from the intermediate transfer belt 25, and is fed to the fixing device 50 according to the endless motion of the paper feeding belt 29 while being held on the top side thereof. The means for performing the primary transfer and the secondary transfer can employ a scorotron charger system instead of the system that applies a transfer bias to the rollers.

A transfer residual toner untransferred on the transfer sheet in the secondary transfer nip is adhered to the surface of the intermediate transfer belt 25 that has passed the secondary transfer nip. The transfer residual toner is scraped off by a belt cleaning device that abuts on the intermediate transfer belt 25.

The transfer sheet fed to the fixing device 50 is pressed and heated in the fixing device 50 so that the full-color image is fixed, after which the transfer sheet is fed to a sheet-discharge roller pair 35 from the fixing device 50 and is discharged out of the copier.

With reference to FIG. 1, the switchback device 36 is provided under the paper feeding unit 28 and the fixing device 50. Accordingly, the advancing path of the transfer sheet that has undergone a process of fixing images on one side thereof is switched toward a transfer sheet flipping device by a switch claw, so that the transfer sheet is flipped over to enter the secondary transfer nip again. After the other side of the transfer sheet undergoes the secondary transfer process and the fixing process, the transfer sheet is discharged on the discharge tray.

The scanner 110 fixed on the printer unit 1 includes a fixed reader 111 and a movable reader 112 as reading means for reading an image of a document MS. The fixed reader 111 that includes a light source, reflection mirrors, and an image read sensor, such as a charge-coupled device (CCD), is disposed directly below a first contact glass (not shown) fixed to the top wall of the casing of the scanner 110, so that the fixed reader 111 contacts the document MS. When the document MS fed by the ADF 120 (described later) passes over the first contact glass, light emitted from the light source is sequentially reflected at the surface of the document MS, and is received by the image read sensor via a plurality of reflection mirrors. Accordingly, the document MS is scanned without moving the optical system that includes the light source and the reflection mirrors.

The movable reader 112 is disposed directly below a second contact glass (not shown) fixed to the top wall of the casing of the scanner 110 and to the right to the fixed reader 111 in FIG. 1, so that the optical system including the light source and the reflection mirrors can be moved in the right and left directions in FIG. 1. In the process of moving the optical system in the right direction from the left side in FIG. 1, light emitted from the light source is reflected at a document (not shown) placed on the second contact glass, and is then received by an image read sensor 113 fixed to the main unit of the scanner 110 via a plurality of reflection mirrors. Accordingly, the document is scanned while moving the optical system.

The ADF 120 disposed above the scanner 110 holds, on a main unit cover 121, a document tray 122 on which a document MS before scanning is placed, a feeding unit 123 for feeding the document MS, and a document stack tray 124 on which scanned documents MS are stacked. The ADF 120 is supported swingable up and down by a hinge (not shown) fixed to the scanner 110. The swinging motion of the ADF 120 is similar to the opening/closing motion of a door. With the ADF 120 open, the contact glass on the top side of the scanner 110 is exposed. Because sheets of a side-bound document like a side-bound book cannot be separated sheet by sheet, the side-bound document cannot be fed out by the ADF 120. For a side-bound document, the ADF 120 is opened to the scanner 110, the side-bound document opened to show a page to be scanned is placed face down on the contact glass, and the ADF 120 is then closed. The image of the target page is scanned by the movable reader 112 of the scanner 110.

A bundle of independent documents MS can be automatically fed sheet by sheet by the ADF 120 to be sequentially scanned by the fixed reader 111 of the scanner 110. In this case, with the document bundle set on the document tray 122, a copy start button (not shown) is depressed. The ADF 120 then feeds the documents MS of the document bundle placed on the document tray 122 into the feeding unit 123 sequentially, and then feeds the documents MS, flipped over, to the document stack tray 124. During the feed, the document MS passes directly over the fixed reader 111 of the scanner 110 immediately after being flipped over. The image of the document MS is then scanned by the fixed reader 111 of the scanner 110.

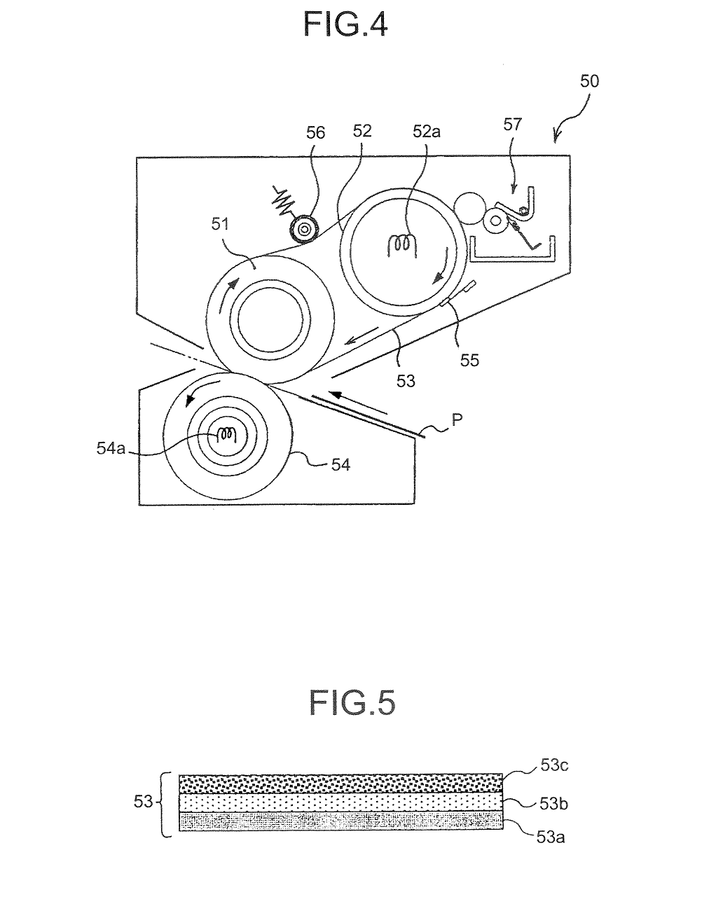

FIG. 4 is an enlarged configuration diagram of the fixing device 50. In FIG. 4, the fixing device 50 includes an endless fixing belt 53 as a belt member stretched while being supported from the bottom side of the loop by a fixing roller 51 and a heating roller 52, which serve as a stretching member. One of the fixing roller 51 and the heating roller 52 is rotated clockwise in FIG. 4 by a driver (not shown). The rotation of the roller causes the fixing belt 53 to move clockwise in FIG. 4 in an endless motion at a linear velocity of 450 mm/s. A pressure roller 54 is disposed under the fixing roller 51. In abutment with the top side of the loop of the fixing belt 53, the pressure roller 54 is pressed toward the fixing roller 51 as a bottom-side roller, which abuts on the bottom side of the loop. This forms a fixing nip where the fixing belt 53 and the pressure roller 54 abut on each other by a length of 18 millimeters in the surface moving direction.

The heating roller 52 encloses a heating source 52a, such as a halogen heater, inside a hollow roller portion made by an aluminum pipe having a high heat conductivity, and heats the bottom side of the fixing belt 53 with the generated heat. A temperature sensor 55 that detects the surface temperature of an object to be detected in a non-contact manner by a well-known technique is disposed below the heating roller 52 in FIG. 4. The temperature sensor 55 detects the surface temperature of that portion of the fixing belt 53 that rolls around the heating roller 52 in a non-contact manner, and sends a detection signal to a temperature controller (not shown). The temperature controller controls the ON/OFF of power supply to the heating source 52a of the heating roller 52 to keep the temperature of the top side of the fixing belt 53 at 175° C. based on the signal sent from the temperature sensor 55. The fixing belt 53 heated this way enters the fixing nip that abuts on the pressure roller 54 according to the endless movement. In the fixing device 50 shown in FIG. 4, since the fixing belt 53 is set sufficiently long with respect to the heating roller 52 as heating means, heat is sufficiently stored in the fixing belt 53.

As shown in FIG. 5, the fixing belt 53 includes a three-layer configuration having a belt base 53a, an elastic layer 53b, and a surface layer 53c. The belt base 53a is made of a polyimide resin excellent in heat resistance formed in an endless shape with a thickness of 90 micrometers. The elastic layer 53b has silicone rubber as an elastic material deposited on the top side of the belt base 53a to a thickness of 200 micrometers. The surface layer 53c has fluorine rubber having excellent heat resistance and toner releasability deposited on the surface of the elastic layer 53b to a thickness of 50 micrometers. Although not shown in FIG. 5 for the sake of convenience, approach stop ribs that are projections extending all around the fixing belt 53 are provided on both widthwise end portions of the bottom side of the fixing belt 53. With the approach stop ribs abutted on the end face of the fixing roller 51 or the heating roller 52 in FIG. 4, the fixing belt 53 is prevented from coming off the roller.

A tension roller 56 that is urged toward the fixing belt 53 by urging means, such as a spring, is pressed against a tensed portion of the fixing belt 53 between the heating roller 52 and the fixing roller 51 from the top side. The abutment applies tension to the fixing belt 53.

The fixing roller 51 has an elastic layer made of silicone rubber or the like having a thickness of about 15 millimeters on the surface of the roller portion made of a metal pipe.

The pressure roller 54 has an elastic layer made of silicone rubber or the like having a thickness of about 2 millimeters and a surface layer made of fluorine rubber having a thickness of about 70 micrometers, sequentially laminated on the surface of the roller portion made of a metal pipe. The pressure roller 54 has a heating source 54a, such as a halogen heater, and a temperature sensor (not shown) inside a hollow roller portion. The temperature sensor detects the temperature inside the roller portion, and sends a detection signal to the temperature controller. The temperature controller controls the ON/OFF of power supply to the heating source 54a of the pressure roller 54 to keep the temperature thereof at 150° C. based on the signal sent from the temperature sensor.

A transfer sheet P having a full-color image transferred thereon by the transfer unit 24 is sent into the fixing nip in the fixing device 50. The transfer sheet P is nipped in the fixing nip between the fixing belt 53 and the pressure roller 54, and is heated from both sides.

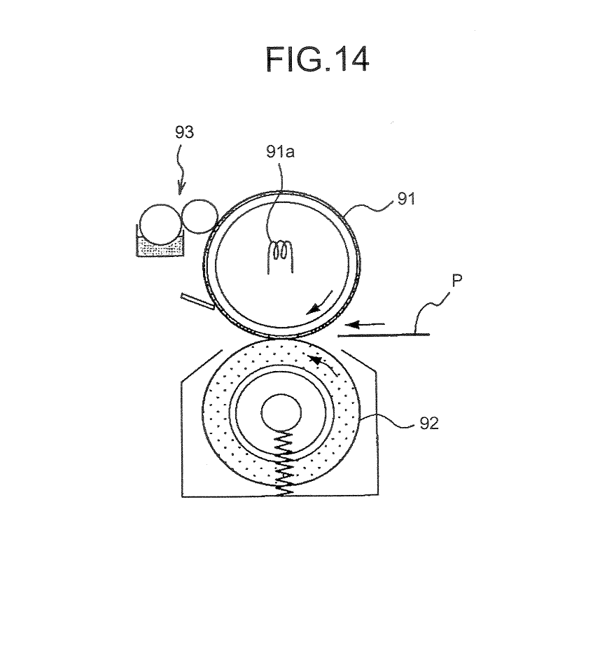

Fixing devices that are used in an electrophotographic image forming apparatus include a belt fixing system as shown in FIG. 4, and the roller fixing system as shown in FIG. 14. In FIG. 14, a fixing device 90 forms a fixing nip by a fixing roller 91 and a pressure roller 92 that abuts on the fixing roller 91. The fixing roller 91 encloses a heating source 91a, such as a halogen lamp, and heats the transfer sheet P, nipped in the fixing nip, with generated heat. The image forming apparatus like the copier of the present invention, which forms a full-color image, generally has a surface layer made of silicone rubber, fluorine rubber or the like provided on the surface of the fixing roller 91, to provide an appropriate gloss level to formed images. An application unit 93 that applies a release promoting oil to the surface of the fixing roller 91 is provided in the fixing device 90 shown in FIG. 14. The application of the release promoting oil to the surface of the fixing roller 91 improves the toner releasability from the fixing roller 91 to suppress the offset of the toner with respect to the fixing roller 91.

Because it is difficult to take a long fixing nip, the fixing device 90 has shortcomings of a poor fixing performance with respect to thick paper and insufficient fixing performance in fast print out. In the case of the belt fixing method like the fixing device 50 shown in FIG. 4, by way of contrast, the fixing nip can be made long easily, so that favorable fixing performance can be demonstrated both for thick paper and in fast print out. In this respect, the image forming method according to the present embodiment forms an image using a copier having the fixing device 50 shown in FIG. 4.

In the belt fixing method, like the fixing device 50 shown in FIG. 4, heating means (heating roller 52 in the example shown in FIG. 4) for heating the fixing belt 53 can be provided at a place separate from the fixing nip. In the configuration, since the fixing belt 53 heated by the heating means is caused to enter the fixing nip while generating the heat in the air, the temperature distribution of the heating member tends to become larger than that of the roller fixing method. Accordingly, the toner heating temperature in the fixing nip is likely to fluctuate. The configuration is also likely to cause a cold offset to transfer a toner image to the fixing belt 53 from a transfer sheet due to an insufficient fixing temperature or cause a hot offset to transfer a toner image to the fixing belt 53 from a transfer sheet due to an excess fixing temperature.

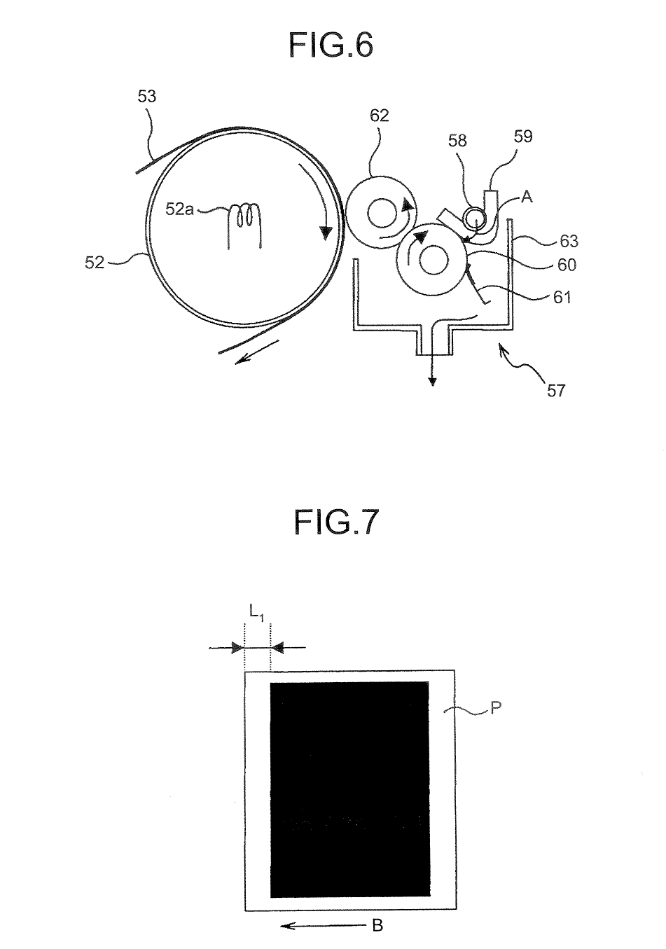

In this respect, the image forming method according to the present embodiment uses the fixing device 50 that includes an application device 57 as application means to apply a release promoting oil to the fixing belt 53. FIG. 6 is an enlarged configuration diagram of the application device 57 together with parts of the heating roller 52 and the fixing belt 53. In FIG. 6, the application device 57 includes an oil discharge pipe 58, a felt 59, a feed roller 60, a restriction blade 61, an application roller 62, and an oil receive tray 63. The application device also includes an oil retaining tank and an oil feed pump (both not shown). The feed roller 60 has an aluminum cored bar, and a surface layer made of silicone rubber coated on the surface of the cored bar. The application roller 62 likewise has an aluminum cored bar, and a surface layer made of silicone rubber coated on the surface of the cored bar.

The release promoting oil is retained in the oil retaining tank (not shown), is supplied into the oil discharge pipe 58 by an operation of an oil supply pump, and is discharged from multiple fine holes (not shown) provided in the oil discharge pipe 58. The release promoting oil is then impregnated with the felt 59 that is in contact with the oil discharge pipe 58. The feed roller 60 is rotated clockwise in FIG. 6 by a driver (not shown) while abutting on the felt 59, the restriction blade 61, and the application roller 62.

The release promoting oil impregnated with the felt 59 moves in the felt 59 in the direction of gravity as shown by an arrow A in FIG. 6 while being diffused in the felt 59 in the pipe's lengthwise direction, and is transferred onto the surface of the feed roller 60. After the thickness of the roller-like liquid film is restricted at the position of abutment between the feed roller 60 and the restriction blade 61, the release promoting oil is supplied onto the surface of the application roller 62 at the position of abutment between the feed roller 60 and the application roller 62. The release promoting oil supplied onto the surface of the application roller 62 this way enters an application nip where the application roller 62 and the fixing belt 53 abut on each other according to the rotation of the application roller 62 that is rotated counterclockwise in FIG. 6 in abutment with the fixing belt 53. The release promoting oil is then applied to the top side of the fixing belt 53 in the application nip. The application amount of the oil to the fixing belt 53 can be adjusted by adjusting the amount of the leading end of the restriction blade 61 biting the feed roller 60.

An excess oil restricted by the restriction blade 61 is received on the oil receive tray 63, and then passes through a drain provided in the bottom portion of the oil receive tray 63 to return into the oil retaining tank (not shown) due to the deadweight.

In the application device 57 having the above configuration, as a release promoting oil, the inexpensive dimethyl silicone oil represented by Formula (3) is generally used. However, the dimethyl silicone oil swells in a silicone rubber, and therefore, when the dimethyl silicone oil is applied to a member having a surface layer made of a silicone rubber, the surface layer easily deteriorates. For example, when the dimethyl silicone oil is applied to a fixing belt having a surface layer made of a silicone rubber, the fixing belt has a life as short as about 10 to 60 kp. On the other hand, the dimethyl silicone oil does not swell in a fluorine rubber and hence, by using a fixing belt having a surface layer made of a fluorine rubber, shortening the life of the belt due to the application of the dimethyl silicone oil can be suppressed. For example, when the dimethyl silicone oil is applied to a fixing belt having a surface layer made of a fluorine rubber, the belt has a life of about 300 to 400 kp. Note that “1 kp” stands for 1000 printouts on recording paper.

However, the dimethyl silicone oil has a poor affinity with a fluorine rubber, and therefore it is difficult to wet the roller surface uniformly and spread thereon with the dimethyl silicone oil. For this reason, a combination of the surface layer made of a fluorine rubber and the dimethyl silicone oil disadvantageously cannot satisfactorily suppress the occurrence of offset of the toner image.

As another release promoting oil applied to a heating member, such as a fixing belt, amino-modified silicone oil comprised mainly of the amino group-containing organopolysiloxane represented by Formula (4) and the amino group-containing organopolysiloxane represented by Formula (5) is known. This amino-modified silicone oil has excellent releasability, and further has excellent affinity with a fluorine rubber and hence can smoothly wet the surface layer made of a fluorine rubber and spread on the surface. However, the amino-modified silicone oil has a disadvantage in that the cost of the materials for the oil is expensive, as compared with that of the dimethyl silicone oil, thus increasing the cost.

The characteristic points of the image forming method according to the present embodiment will be described next.

The inventors prepared a prototype having the same configuration as that of the copier shown in FIGS. 1 to 3. The prototype was equipped with the fixing device 90 shown in FIG. 14, and a dimethyl silicone oil represented by Formula (3) was set as a release promoting oil to be applied to the fixing roller 91. While the fixing temperature was changed from 130° C. to 210° C., a test image was printed out at each fixing temperature, and the image quality and the occurrence of a toner image on the fixing roller 91 were evaluated. The fixing roller 91 in use was a roller having fluorine rubber coated on the surface thereof and having a diameter of 100 millimeters. The pressure roller 92 in use had a diameter of 100 millimeters, and a nip width (the length of the fixing nip in the moving direction of the roller surface) set to 13 millimeters. Transfer sheets in use were standard paper (55 kg paper) generally used in a copier or the like and thick paper (300 g/m²). A test image used had a solid image output following a margin with a length L1 (5 millimeters) at the leading end in a paper feeding direction B of a transfer sheet P of A4 paper size, as shown in FIG. 7.

The fixing device to be installed in the prototype was then changed from the fixing device 90 shown in FIG. 14 to the fixing device 50 of the belt fixing method shown in FIG. 4. While the surface temperature (fixing temperature) of the fixing belt 53 was changed from 130° C. to 210° C., a test image was printed out at each fixing temperature, and the image quality and the occurrence of a toner image on the fixing belt 53 were evaluated. As a release promoting oil, a dimethyl silicone oil was used as in the roller fixing method.

The results of the experiment are shown in Table 1 below.

TABLE 1

| Fixing | Paper | Fixing temperature (° C.) | | | | | | | | |
|---|---|---|---|---|---|---|---|---|---|---|
| method | thickness | 130 | 140 | 150 | 160 | 170 | 180 | 190 | 200 | 210 |
| Roller | Thin paper | X | X | | | | ▴ | X | X | X |
| fixing | (55 kg | | | | | | | | | |
| method | paper) | | | | | | | | | |
| (Nip width | Thick | X | X | X | X | X | | | | |
| 13 mm) | paper (300 | | | | | | | | | |
| | g/m²) | | | | | | | | | |
| Belt | Thin paper | X | | | | ▴ | X | X | X | X |
| fixing | (55 kg | | | | | | | | | |
| method | paper) | | | | | | | | | |
| (Nip width | Thick | X | X | X | | | | | | |
| 18 mm) | paper (300 | | | | | | | | | |
| | g/m²) | | | | | | | | | |

: No offset
X: Offset occurred
▴: Uneven gloss occurred

It is understood from Table 1 that the belt fixing method can make larger the fixing temperature range where proper fixing can be carried out without causing an offset as compared with the roller fixing method. This is because the belt fixing method has a wider nip width and can make the fixing nip passing time of the transfer sheet longer. In either method, uneven gloss can occur on the high temperature side. This uneven gloss occurs when standard paper is fixed at a higher fixing temperature, and a fixing temperature of uneven gloss significantly changes due to the type of the oil, the uniformness of oil application, sheet separability, and so forth. The uneven gloss is originated from local generation of portions in an image that reduce the gloss, and considerably degrades the image quality. In the roller fixing method, there is no fixing temperature region where prevention of the occurrence of uneven gloss on standard paper and prevention of offset when a thick sheet is used can both be achieved. The belt fixing method can however have such a fixing temperature region (160° C.) where both preventions can be achieved.

The inventors then made evaluations in which three types of release promoting oils were individually set in a tester having the fixing device 50 of a belt fixing system shown in FIG. 4 and the image quality, and the occurrence of offset were examined with respect to each oil. One of the three types of release promoting oils is the inexpensive dimethyl silicone oil represented by Formula (3). Hereinafter, this oil is referred to as “inexpensive conventional oil”. Another one is the expensive amino-modified silicone oil represented by Formulas (4) and (5). Hereinafter, this oil is referred to as “expensive conventional oil”. The remaining one is oil comprising a mixture of the dimethyl polysiloxane represented by Formula (1) and the amino group-containing dimethyl polysiloxane represented by Formula (2). Hereinafter, this oil is referred to as “oil according to the present embodiment”.

The results of the experiment are shown in Table 2 below.

TABLE 2

| | Paper | Fixing temperature (° C.) | | | | | | | | |
|---|---|---|---|---|---|---|---|---|---|---|
| Type of oil | thickness | 130 | 140 | 150 | 160 | 170 | 180 | 190 | 200 | 210 |
| Oil | Thin | X | | | | | | | ▴ | X |
| according | paper (55 | | | | | | | | | |
| to the | kg) | | | | | | | | | |
| present | Thick | X | X | X | | | | | | |
| embodiment | paper | | | | | | | | | |
| | (300 g/m²) | | | | | | | | | |
| Inexpensive | Thin | X | | | | ▴ | X | X | X | X |
| conventional | paper (55 | | | | | | | | | |
| oil | kg) | | | | | | | | | |
| | Thick | X | X | X | | | | | | |
| | paper | | | | | | | | | |
| | (300 g/m²) | | | | | | | | | |
| Expensive | Thin | X | | | | | | | ▴ | X |
| conventional | paper (55 | | | | | | | | | |
| oil | kg) | | | | | | | | | |
| | Thick | X | X | X | | | | | | |
| | paper | | | | | | | | | |
| | (300 g/m²) | | | | | | | | | |

: No offset
X: Offset occurred
▴: Uneven gloss occurred

From Table 2, it is understood that, when using standard paper, the oil according to the present embodiment or expensive conventional oil can have a wide region of the fixing temperature in which excellent fixing free of offset can be achieved, as compared with the inexpensive conventional oil. When a test image was output on standard paper using the inexpensive conventional oil, uneven gloss was caused at a fixing temperature of 170° C. or higher. In addition, hot offset occurred at a fixing temperature of 180° C. or higher. In contrast, with respect to each of the oil according to the present embodiment and the expensive conventional oil, it is found that, when using standard paper, uneven gloss was not caused even at a fixing temperature of 190° C. or higher. Hot offset occurred when the releasability of the toner from the fixing belt 53 became poor at too high a fixing temperature; however, the oil according to the present embodiment or expensive conventional oil was advantageously improved in releasability of the toner from the fixing belt 53 to prevent the occurrence of hot offset at 190° C. It has already been known that the expensive conventional oil can be improved in releasability as mentioned above; however, it is found that the oil according to the present embodiment developed by the inventors can achieve the similar effect. For reference, the way in which the oil according to the present embodiment wets the surface of the fixing belt 53 and spreads thereon was visually checked. As a result, it was confirmed that the oil according to the present embodiment smoothly wetted the surface, as compared with the inexpensive conventional oil.

The oil according to the present embodiment includes, as shown in Formula (1), a mixture of the dimethyl silicone oil (Formula (1)), which has conventionally been generally used, and an amino group-containing dimethyl polysiloxane represented by Formula (2). The amino group-containing dimethyl polysiloxane improves the releasability of the toner from the fixing belt 53. Therefore, when the ratio of the amino group-containing dimethyl polysiloxane to the oil is too low, the effect to improve the releasability cannot be obtained. Depending on the ratio of the amino group-containing dimethyl polysiloxane to the oil, the cost of the oil according to the present embodiment can be equal to or higher than the cost of the expensive conventional oil.

The inventors made experiments as follows. A plurality of types of oils in the present embodiment having different ratios between the dimethyl silicone oil and the amino group-containing dimethyl polysiloxane were prepared, and the image quality and the occurrence of offset were evaluated with respect to each oil according to the present embodiment. As a result, it has been found that, when the amino group-containing dimethyl polysiloxane is mixed in an amount as small as 0.5 part by weight (0.5%) into 100 parts by weight of a mixture of the dimethyl polysiloxane and the amino group-containing dimethyl polysiloxane (99.5:0.5 in weight ratio), excellent releasability similar to that shown in Table 2 can be obtained. In addition, it has been found that, when the amount of the amino group-containing dimethyl polysiloxane is larger than 10 parts by weight (90:10 in weight ratio), the cost of the oil according to the present embodiment can be lower than that of the expensive conventional oil. However, the oil disadvantageously has a viscosity of higher than 1×10⁻² m²/s (10000 centi-strokes (cst)) at 25° C. Further, it has been found that the oil having a viscosity of higher than 1×10⁻³ m²/s is considerably lowered in wettability for the belt surface, thus lowering the initial releasability. The oil according to the present embodiment having a viscosity of lower than 1×10⁻⁵ m²/s (10 cst) at 25° C. was considerably highly volatile in an environment at high temperatures and hence was not able to remain in its oil state unless the fixing device 50 was tightly closed. Therefore, it is desired that the oil according to the present embodiment having a viscosity of 1×10⁻⁵ to 1×10⁻² m²/s (10 to 10000 cst) at 25° C. is used. Oil having a ratio (dimethyl polysiloxane:amino group-containing dimethyl polysiloxane) of 90:10 to 99.5:0.5 and having a viscosity of 1×10⁻⁵ to 1×10⁻² m²/s at 25° C. is used as the oil according to the present embodiment in the image forming method according to the present embodiment.

In the experiments, a viscosity having a unit “cst” was determined. However, the unit “cst” was converted to “m²/s” using Formula of “1 cst=1×10⁻⁶ m²/s”. In this case, the resultant figure was rounded to five decimals. The dimethyl polysiloxane of Formula (1) has a viscosity of 10 to 5,000 cst=1×10⁻⁵ to 5×10⁻³ m²/s.

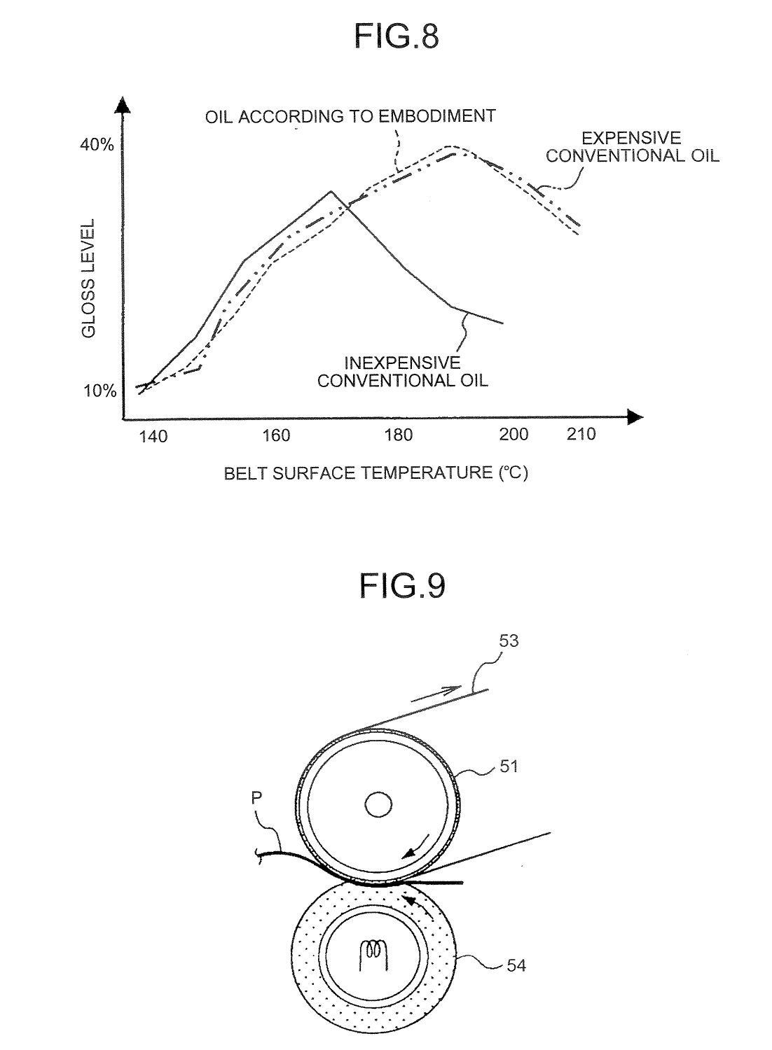

For reference, a relationship between the surface temperature of the fixing belt 53 (fixing temperature) and gloss levels of a test image is plotted on a graph shown in FIG. 8. As understood from the graph of FIG. 8, the oil according to the present embodiment can offer an image having a gloss level as excellent as achieved by the expensive conventional oil.

The cost ratios of the individual oils to the inexpensive conventional oil of which the cost is taken as “1” are shown in Table 3 below.

TABLE 3

| Type of oil | Cost ratio |
|---|---|
| Oil according to the present embodiment | 1.09 |
| Inexpensive conventional oil | 1.00 |
| Expensive conventional oil | 2.27 |

In Table 3, with respect to the oil according to the present embodiment, the cost ratio of the oil having a composition (dimethyl polysiloxane:amino group-containing dimethyl polysiloxane=90:10) at which the cost of the oil is the highest is shown. As can be seen from Table 3, even in the composition at which the cost is the highest, the oil according to the present embodiment has a cost ratio as low as 1.09, which corresponds to the cost substantially the same as that of the inexpensive conventional oil. By contrast, the expensive conventional oil has a cost 2.27 times the cost of the inexpensive conventional oil.

The inventors prepared two types of fixing devices as the fixing device 50 shown in FIG. 4. One of the fixing devices is configured in such a way as shown in FIG. 9, the elastic layer made of rubber coated on the roller portion of the pressure roller 54 is made thicker and softer than the elastic layer made of rubber coated on the roller portion of the fixing roller 51. With the configuration, as shown in FIG. 9, the fixing roller 51 bites the softer pressure roller 54 via the fixing belt 53. As a result, a protrusive fixing nip is formed. The transfer sheet P having passed the fixing nip is promptly separated from the pressure roller 54, moves so as to slightly wind around the fixing belt 53 stretching along the curvature of the fixing roller 51, and is then separated from the fixing belt 53.

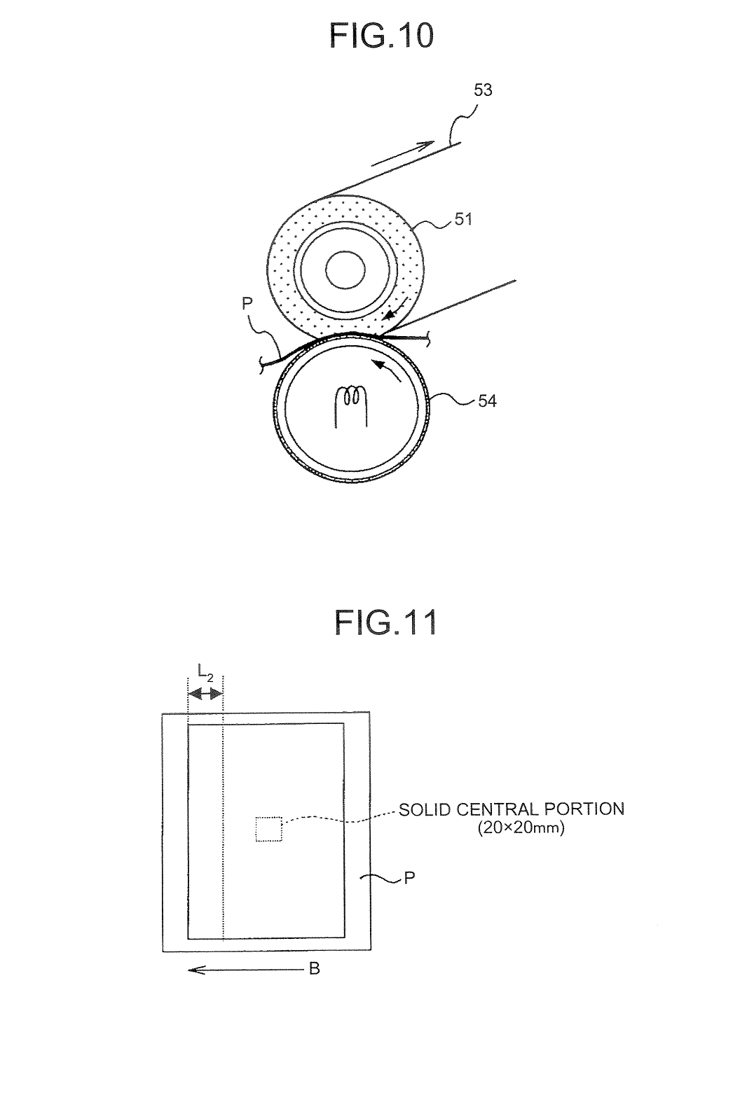

The other one of the two fixing devices 50 is configured in such a way as shown in FIG. 10, the elastic layer made of rubber coated on the roller portion of the fixing roller 51 is made thicker and softer than the elastic layer made of rubber coated on the roller portion of the pressure roller 54. With the configuration, as shown in FIG. 10, the pressure roller 54 sinks in the softer fixing roller 51 via the fixing belt 53. As a result, a pressure protrusive fixing nip is formed. The transfer sheet P having passed the fixing nip is promptly separated from the fixing belt 53, moves so as to slightly wind around the pressure roller 54, and is then separated from the pressure roller 54.

The inventors conducted an experiment for these two types of fixing devices 50 to print out the test image shown in FIG. 7 and check the gloss level of the test image. The results are given in Table 4 below. The gloss level was measured by illuminating a solid pattern of 1 inch×1 inch or larger with a 100% print ratio using a gloss meter (VG2000) produced by Nippon Denshoku Industries Co., Ltd. The incident angle and reflection angle of the light were both set to 60°.

TABLE 4

Gloss level (%)

| | Leading | Central |
|---|---|---|
| Nip shape | end | portion |
| Protrusive fixing nip (FIG. 9) | 16 | 38 |
| Pressure protrusive fixing nip | 38 | 38 |
| (FIG. 10) | | |

As shown in Table 4, in the case of the protrusive fixing nip (FIG. 9), the gloss level at the leading end of the test image is lower than that at the central portion, causing uneven gloss. In the case of the pressure protrusive fixing nip (FIG. 10), a high gloss level is acquired both at the leading end and at the central portion of the test image, causing no uneven gloss. It is therefore understood that forming the pressure protrusive fixing nip can ensure a higher image quality than forming the protrusive fixing nip.

It is to be noted that in the case of the pressure protrusive fixing nip, as shown in FIG. 10, the rubber layer of the fixing roller 51 is made relatively thick, so that if the heating source for heating the fixing belt 53 is provided inside the fixing roller 51, the amount of the stored heat of the fixing roller 51 is increased. In addition, it takes a longer warm-up time to raise the surface temperature of the fixing belt 53 to a desired fixing temperature after the initiation of the power supply to the heating source. Further, the configuration impairs the response to the belt surface temperature that is changed by the ON/OFF of the power supply to the heating source in continuous printout that requires continuous feeding of a plurality of transfer sheets P to the fixing nip.

In consideration of the point, the fixing device 50 as shown in FIG. 10 has a heating source provided in the heating roller 52 that does not need to make the elastic layer thick as shown in FIG. 4, not in the fixing roller 51 that should make the elastic layer thick. After the fixing belt 53 is heated at the location where the fixing belt 53 is wound around the heating roller 5′, the fixing belt 53 enters the fixing nip. In the configuration, to secure a certain amount of heat stored, it is typical to provide the elastic layer 53b between the belt base 53a and the surface layer 53c of the fixing belt 53 as shown in FIG. 5. However, this inevitably causes an uneven temperature due to a variation in the thickness of the elastic layer 53b. To prevent the occurrence of hot offset even when the temperature becomes uneven, therefore, it is necessary to secure a certain non-offset fixing temperature region. This requires the use of the oil according to the present embodiment or an expensive conventional oil.

In view of these circumstances, the image forming method of the present invention uses the fixing device 50 that forms a pressure protrusive fixing nip shown in FIG. 10, heats the fixing belt 53 with the heating roller 52, and uses the oil according to the present embodiment. The fixing roller 51 in use has an elastic layer made of silicone rubber having a thickness of 15 millimeters and JIS-A rubber hardness of 30 Hs coated on an aluminum cored bar. The pressure roller 54 in use has an elastic layer made of silicone rubber having a thickness of 2 millimeters and JIS-A rubber hardness of 32 Hs coated on an aluminum cored bar. The pressure roller 54 is pressed toward the fixing roller 51 at the pressure of the gloss load 130 kilogram-force (kgf). This configuration can form a pressure protrusive fixing nip.

The inventors prepared, as the fixing device 50 with such a configuration, two types of fixing devices in which the materials for the surface layers of the pressure rollers 54 differ from each other. One has a surface layer made of PFA coated on the elastic layer of the pressure roller 54. The other one has a surface layer made of fluorine rubber coated on the elastic layer of the pressure roller 54 to a thickness of 70 micrometers.

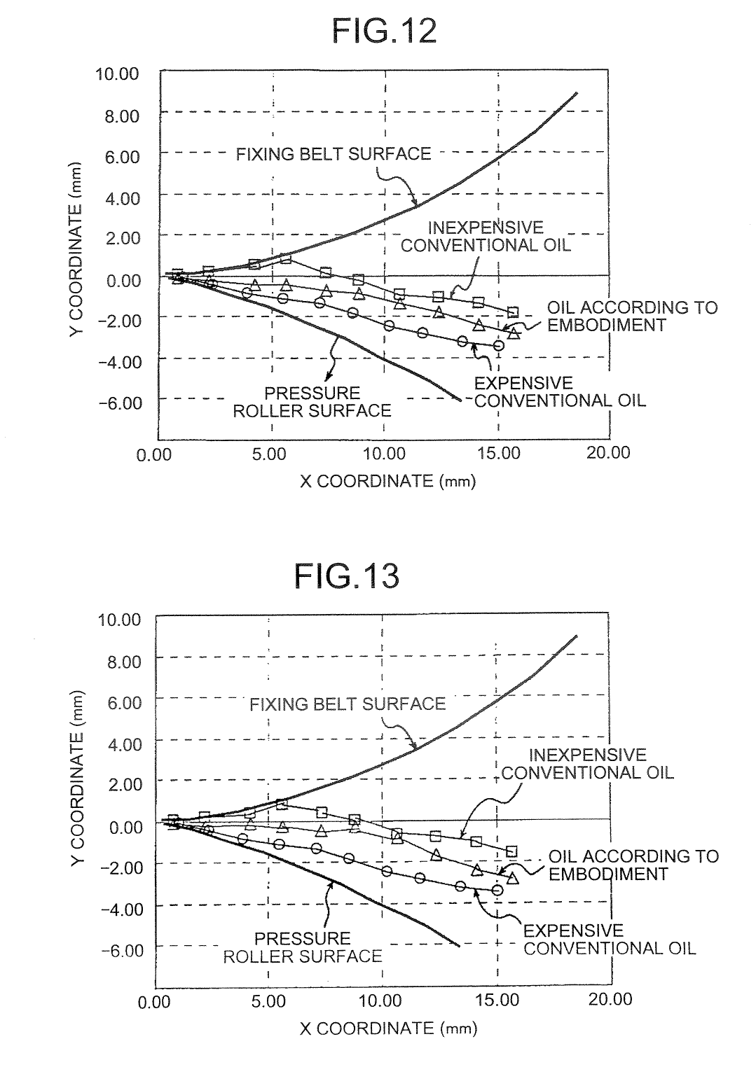

The inventors first installed the fixing device 50 having the surface layer made of PFA coated on the pressure roller 54 in the prototype. The inventors then checked the behavior of the transfer sheet P when printing the test image thereon and the gloss level of the test image for each of the three types of release promoting oils. As the transfer sheet P, standard paper (55 kg paper) was used. The test image used had a solid image output following a margin with a length L2 (20 millimeters) at the leading end in the paper feeding direction B of the transfer sheet P, as shown in FIG. 11. The solid central portion (described later) is a solid portion with a size of 20×20 millimeters in the center of the solid image. After the test image was formed on one side of the transfer sheet P and passed through the fixing device 50, the transfer sheet P was switched back toward the transfer unit 24 by the switchback device 36 shown in FIG. 1. A similar test image was then formed on the other side of the transfer sheet P and passed through the fixing device 50 again. The state of the transfer sheet P after passing the fixing nip again was picked up using a high-speed camera to evaluate the behavior of the transfer sheet P. FIG. 12 is a graph of relationships among the discharge amount (X coordinate) of the transfer sheet P from the fixing nip in the experiment, the position (Y coordinate) in a direction perpendicular to the transfer sheet P, and the type of the oil. The relationship between the oil type and the gloss level of the test image on each side of the transfer sheet P is shown in Table 5 below. In Table 5, the side S is one of two sides of the transfer sheet P on which the test image was transferred first, and the side D is the other side of the transfer sheet P.

TABLE 5

| Gloss level (%) | |
|---|---|
| Side S | Side D |

| | Leading | Central | Leading | Central |
|---|---|---|---|---|
| Type of oil | end | portion | end | portion |
| Oil according to | 25 | 25 | 38 | 38 |
| the present | | | | |
| embodiment | | | | |
| Inexpensive | 16 | 25 | 16 | 38 |
| conventional oil | | | | |
| Expensive | 25 | 25 | 38 | 38 |
| conventional oil | | | | |

The inventors then changed the fixing device 50 to be set in the prototype to the one having the surface layer made of fluorine rubber (fluorine rubber latex, produced by Nitto Kogyo Corporation) coated on the pressure roller 54. A test image was printed out in the same way as done in the case of the fixing device having the surface layer made of PFA coated on the pressure roller 54. FIG. 13 is a graph of relationships among the discharge amount (X coordinate) of the transfer sheet P from the fixing nip in the experiment, the position (Y coordinate) in a direction perpendicular to the transfer sheet P, and the type of the oil. The relationship between the oil type and the gloss level of the test image on each side of the transfer sheet P is shown in Table 6 below.

TABLE 6

| Gloss level (%) | |
|---|---|
| Side S | Side D |

| | Leading | Central | Leading | Central |
|---|---|---|---|---|
| Type of oil | end | portion | end | portion |
| Oil | 38 | 38 | 38 | 38 |
| according to | | | | |
| the present | | | | |
| embodiment | | | | |
| Inexpensive | 16 | 38 | 16 | 38 |
| conventional | | | | |
| oil | | | | |
| Expensive | 25 | 38 | 38 | 38 |
| conventional | | | | |
| oil | | | | |

When the pressure roller 54 in use has the surface layer made of PFA coated thereon, the use of an inexpensive conventional oil causes the transfer sheet P discharged from the fixing nip to behave as follows as shown in FIG. 12. The transfer sheet P moves toward the fixing belt 53, which moves along the curvature of the fixing roller 51, while being wound around the fixing belt 53, and is then separated from the belt surface. With an expensive conventional oil used, the transfer sheet P discharged from the fixing nip moves while being wound around the pressure roller 54, and is then separated from the roller surface. With the use of the oil according to the present embodiment, the transfer sheet P discharged from the fixing nip moves in response to the movement of the surface of the pressure roller 54 momentarily, and is then promptly separated from both the fixing belt 53 and the pressure roller 54. With the use of the inexpensive conventional oil, as shown in Table 5, the gloss level at the leading end of the test image was lower than that at the central portion for both sides S and D, showing uneven gloss. With the use of the oil according to the present embodiment and the expensive conventional oil, while uneven gloss did not appear in the test image for both sides S and D, the gloss level of the test image on the side S was lower than that of the test image on the side D, causing uneven gloss between both sides.

On the other hand, when the pressure roller 54 in use has the surface layer made of fluorine rubber coated thereon, the use of an inexpensive conventional oil causes the transfer sheet P discharged from the fixing nip to behave as follows as shown in FIG. 13. The transfer sheet P moves toward the fixing belt 53, which moves along the curvature of the fixing roller 51, while being wound around the fixing belt 53, and is then separated from the belt surface. As understood from the comparison with the behavior shown in FIG. 12, this behavior is approximately the same as the one when the pressure roller 54 having the surface layer made of PFA coated thereon is used. With an expensive conventional oil used, as shown in FIG. 13, the transfer sheet P discharged from the fixing nip moves while being wound around the pressure roller 54, and is then separated from the roller surface. As understood from the comparison with the behavior shown in FIG. 12, this behavior is approximately the same as the one when the pressure roller 54 having the surface layer made of PFA coated thereon is used. With the use of the oil according to the present embodiment, the transfer sheet P discharged from the fixing nip moves substantially straight without being wound around the pressure roller 54 or the fixing belt 53. As understood from the comparison with the behavior shown in FIG. 12, this behavior indicates that the separation performance from the pressure roller 54 becomes higher than that in the case of using the pressure roller 54 having the surface layer made of PFA coated thereon is used. As understood from Table 6, a satisfactory result was obtained in that uneven gloss in the test image between the side S and the side D was avoided in addition to no uneven gloss appeared in the test image on both sides S and D. In contrast, the use of the inexpensive conventional oil caused uneven gloss in the test image. The use of the expensive conventional oil causes uneven gloss in the test image as well as uneven gloss in the test image between sides S and D. In the case of the expensive conventional oil, it seems that because the transfer sheet P discharged from the fixing nip moves while being slightly wound around the pressure roller 54, the leading end of the side S is excessively heated, resulting in a lower gloss level at the leading end.

In consideration of the experimental results, the image forming method of the present invention uses the pressure roller 54 that has the surface layer made of fluorine rubber coated on the elastic layer made of silicone rubber having a thickness of 2 millimeters and JIS-A rubber hardness of 32 Hs.

The inventors then changed the application amount of the oil to the fixing belt 53 from the application roller 62 in the fixing device 50 with the configuration to various values by adjusting the bite amount of the restriction blade 61 to the feed roller 60. The inventors then conducted an experiment to check the occurrence of uneven gloss in the test image and the occurrence of offset for each oil application amount. With regard to the oil application amount, an OHP sheet whose weight was measured in advance was passed through the fixing device 50, the weight of the OHP sheet thereafter was measured by a precision scale, and the difference between the weights before and after passing the OHP sheet through the fixing device 50. Because the OHP sheet was of the A4 paper size, the weight difference divided by the area of A4 paper size (21 cm×29.7 cm) was taken as the oil application amount per unit area. The results are shown in Table 7 below.

TABLE 7

| Oil application | Surface temperature of fixing belt (° C.) | | | | | | | | |
|---|---|---|---|---|---|---|---|---|---|
| amount X | 130 | 140 | 150 | 160 | 170 | 180 | 190 | 200 | 210 |
| X < 0.0008 | X | | X | X | X | X | X | X | X |
| 0.0008 ≦ X < 0.0016 | X | | | | | X | X | X | X |
| 0.0016 ≦ X < 0.0064 | X | | | | | | | ▴ | X |
| 0.0064 ≦ X < 0.0192 | X | | | | | | | ▴ | X |

: No offset
X: Offset occurred
▴: Uneven gloss occurred

It is understood from Table 7 that as the oil application amount to the fixing belt 53 increases, the releasability of the toner from the fixing belt 53 becomes higher and the range of the hot-offset occurring fixing temperature becomes wider toward the high temperature side. When the oil application amount is 0.0016 mg/cm² or larger, the range of the hot-offset occurring fixing temperature does not become wider toward the high temperature side even if the oil application amount is increased. It is found that setting the oil application amount to 0.0016 mg/cm² or larger can make the releasability of the toner from the fixing belt 53 higher.

The inventors then conducted an experiment of writing letters with a ball-point pen, on the transfer sheet P having the test image printed thereon with each oil application amount, and checking the writing properties. The results are shown in Table 8 below.

TABLE 8

| Oil application amount X | Writing property |
|---|---|
| X < 0.0008 | OK |
| 0.0008 ≦ X < 0.0016 | OK |
| 0.0016 ≦ X < 0.0192 | OK |
| X ≧ 0.0192 | Letters become thinner |

When the oil application amount is too large, the oil adhered to the transfer sheet P is likely to deteriorate the writing properties with a ball-point pen or the like. As shown in Table 8, the oil application amount of 0.0192 mg/cm² or larger made letters written with a ball-point pen thinner.

In consideration of the experimental results, the image forming method of the present invention uses the fixing device 50 that has the oil application amount adjusted to 0.0016 to 0.0192 mg/cm² by adjusting the bite amount of the restriction blade 61 and the number of rotations of the feed roller 60.

The inventors changed the fixing belt 53 to be provided in the fixing device 50 with the three-layer configuration shown in FIG. 5 to the following belt and evaluated the image quality. The fixing belt 53 to be replaced has only a surface layer 50c of fluorine rubber having a thickness of 100 micrometers provided on a belt base 50a. This configuration caused uneven gloss of a lattice pattern in the solid portion of the test image.

The inventors conducted a similar experiment using the fixing belt 53 having only the surface layer 50c of fluorine rubber having a thickness of 100 micrometers provided on the belt base 50a. The offset occurring fixing temperature was reduced to the low temperature side. This indicates that the releasability became lower. The fluorine rubber in use was fluorine rubber latex manufactured by Nitto Kogyo Corporation.

In the image forming method according to the present embodiment described above, there is used a release promoting oil containing, relative to 100 parts by weight of the mixture of the dimethyl polysiloxane represented by Formula (1) and the amino group-containing dimethyl polysiloxane represented by Formula (2), the amino group-containing dimethyl polysiloxane in an amount of 0.5 to 10 parts by weight. This release promoting oil, as mentioned above, not only exhibits toner releasability for the fixing belt 53 as excellent as achieved by the expensive conventional oil to prevent the occurrence of hot offset or uneven gloss, but also realizes a lower cost than that of the expensive conventional oil.

Further, the release promoting oil used has a viscosity of 1×10⁻⁵ to 1×10⁻² m²/s at 25° C. The release promoting oil, as mentioned above, avoids the lowering of the initial releasability due to the poor wettability for the surface of the fixing belt 53, and does not require any operation of tightly closing the fixing device 50 for preventing the oil from volatilizing.

As the fixing belt 53 that is a belt member, there is used a fixing belt including the belt base 53a made of polyimide having formed on its surface side the elastic layer 53b made of a silicone rubber as an elastic material, and the surface layer 53c made of a fluorine rubber as a fluororesin. In this case, the toner releasability from the belt can be improved, as compared with the releasability achieved when using the fixing belt 53 having no elastic layer.

The oil according to the present embodiment that is a release-promoting agent is applied to the top side of the fixing belt 53 in a coating weight of 0.0016 to less than 0.0192 mg/cm2. In this case, as mentioned above, not only can excellent toner releasability from the fixing belt 53 be obtained, but also excellent writing properties on printouts can be obtained.

With the fixing roller 51 as a bottom-side roller abutting on the bottom side of the fixing belt 53, the pressure roller 54 harder than the fixing roller 51 is pressed toward the fixing roller 51 in abutment with the top side of the fixing belt 53 to cause the fixing belt 53 and the pressure roller 54 to abut on each other, thereby forming a pressure protrusive fixing nip, so that the cross section of the abutment surface of the pressure roller 54 is dented toward the fixing roller 51, and the transfer sheet P as a recording medium is nipped by the fixing nip to press the fixing belt 53 against the surface of the transfer sheet P. This can suppress uneven gloss in a single image as compared with the case of forming a protrusive fixing nip.

In addition, the pressure roller in use has a surface layer made of fluorine rubber coated thereon. This can suppress uneven gloss in a single image and uneven gloss in an image between both sides of the transfer sheet P, as compared with the case of the pressure roller in use has a surface layer made of PFA coated thereon.

The inventors have found from the experiments that, when a release-promoting agent comprising a mixture of the inexpensive dimethyl polysiloxane (Formula (1)), which has conventionally been generally used, and a small amount of the amino group-containing dimethyl polysiloxane represented by Formula (2) is applied to the heating member, the occurrence of offset of the toner image to the heating member can be prevented as satisfactorily as prevented by the above expensive amino-modified silicone oil (Formula (4)+Formula (5)). This release-promoting agent comprises a mixture of the inexpensive dimethyl polysiloxane and a small amount of the expensive amino group-containing dimethyl polysiloxane, and is inexpensive, as compared with the amino-modified silicone oil {Formula (4)+Formula (5)} comprised mainly of the expensive amino group-containing organopolysiloxane. Therefore, according to the present invention, the occurrence of offset of a toner image to a heating member, e.g., a fixing belt for heating a recording medium can be stably prevented at a low cost.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth

What is claimed is:

1. A release-promoting agent configured to be applied to a heating member in a fixing device that presses the heating member against a recording medium on which a toner image is formed, and fixes the toner image to the recording medium, to promote release of the toner image from the heating member, wherein
the release-promoting agent is formed with a mixture of a dimethyl polysiloxane represented by 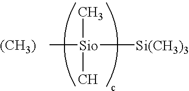
and an amino group-containing dimethyl polysiloxane represented by 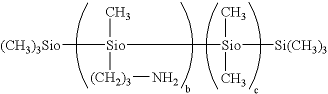
where b≠0, and c>1000.

2. The release-promoting agent according to claim 1, wherein
an amount of 0.5 part by weight to 10 parts by weight of the amino group-containing dimethyl polysiloxane is contained per 100 parts by weight of the mixture of the dimethyl polysiloxane and the amino group-containing dimethyl polysiloxane.

3. The release-promoting agent according to claim 1, wherein
a viscosity of the release-promoting agent at a temperature of 25 degrees Celsius is 1×10⁻⁵ m²/s to 1×10⁻² m²/s.

4. A fixing device comprising:
an endless belt member that is tightly stretched by a plurality of tension members, and moves in an endless motion;
a bottom-side roller that abuts on a back surface of the belt member;
a pressure roller that is pressed toward the bottom-side roller in abutment with a surface of the belt member;
a heating unit that heats the belt member; and
an applying unit that applies a release-promoting agent to the surface of the belt member, wherein
the recording medium on which a toner image is formed is nipped by a fixing nip formed by abutment of the belt member and the pressure roller, and is heated, thereby fixing the toner image on the recording medium, and
the release-promoting agent is formed with a mixture of a dimethyl polysiloxane represented by 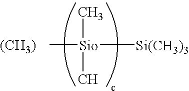
and an amino group-containing dimethyl polysiloxane represented by 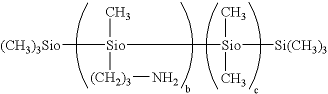
where b≠0, and c>1000.

5. The fixing device according to claim 4, wherein the belt member includes
a belt base formed with a polyimide;
an elastic layer formed on a surface of the belt base; and
a surface layer, which is made of a fluororesin, formed on the elastic layer.

6. The fixing device according to claim 4, wherein
the release-promoting agent is applied to the surface of the belt member by an amount equal to or greater than 0.0016 mg/cm² and less than 0.0192 mg/cm².

7. The fixing device according to claim 4, wherein
the fixing nip is formed by abutting the bottom-side roller on the back surface of the belt member and pressing the pressure roller harder than the bottom-side roller toward the bottom-side roller in abutment with the surface of the belt member to cause the belt member and the pressure roller to abut on each other, so that a cross section of an abutment surface of the pressure roller is dented toward the bottom-side roller, and
the belt member is pressed against the surface of the recording medium by nipping the recording medium in the fixing nip.

8. The fixing device according to claim 7, wherein
the pressure roller is coated with a surface layer made of fluorine rubber.

9. An image forming apparatus comprising:
a forming unit that forms a toner image on a recording medium; and
a fixing device that fixes the toner image on the recording medium, wherein
the fixing device includes
an endless belt member that is tightly stretched by a plurality of tension members, and moves in an endless motion;
a bottom-side roller that abuts on a back surface of the belt member;
a pressure roller that is pressed toward the bottom-side roller in abutment with a surface of the belt member;
a heating unit that heats the belt member; and
an applying unit that applies a release-promoting agent to the surface of the belt member,
the recording medium on which a toner image is formed is nipped by a fixing nip formed by abutment of the belt member and the pressure roller, and is heated, thereby fixing the toner image on the recording medium, and
the release-promoting agent is formed with a mixture of a dimethyl polysiloxane represented by 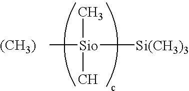
and an amino group-containing dimethyl polysiloxane represented by 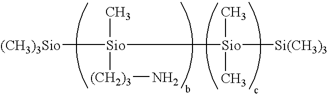
where b≠0, and c>1000.
